(19) United States
(12) Patent Application Publication
(10) Pub. No.: US 2021/0137342 A1
(43) Pub. Date: May 13, 2021

(54) SELF-PROPELLED VACUUM CLEANER

(71) Applicant: Chiba institute of technology, Chiba (JP)

(72) Inventors: Takayuki FURUTA, Chiba (JP); Masahiro TOMONO, Chiba (JP); Hideaki YAMATO, Chiba (JP); Tomoaki YOSHIDA, Chiba (JP); Masaharu SHIMIZU, Chiba (JP); Yu OKUMURA, Chiba (JP); Kengo TODA, Chiba (JP); Takashi KODACHI, Chiba (JP); Kiyoshi IRIE, Chiba (JP); Yoshitaka HARA, Chiba (JP); Kazuki OGIHARA, Chiba (JP)

(21) Appl. No.: 16/617,139

(22) PCT Filed: Jun. 7, 2017
(86) PCT No.: PCT/JP2017/021101

§ 371 Date: Nov. 26, 2019

(51) Int. Cl. A47L 11/40; A47L 9/00; A47L 9/28

(52) U.S. Cl. CPC A47L 11/4061; A47L 9/009; A47L 9/2852; A47L 2201/04; A47L 11/4011; A47L 11/4066; A47L 9/2826

(57) ABSTRACT

Provided is a self-propelled vacuum configured so that obstacle avoidance operation can be efficiently performed and cleaning time can be shortened. A self-propelled vacuum 1 includes a laser range finder (LRF) 20 configured to sense the periphery of a vacuum body 2, and an up-down drive unit 22 configured to move the LRF 20 up and down between a protrusion position above the vacuum body 2 and a housing position in the vacuum body 2. The up-down drive unit 22 is driven to move the LRF 20 up and down.

### TECHNICAL FIELD

The present invention relates to a self-propelled vacuum.

### BACKGROUND ART

Typically, one including a traveling section configured to cause a vacuum body to travel and a suction section configured to suck dust or the like into a dust collection chamber in the vacuum body through a suction port has been known as a self-propelled vacuum (a cleaning robot) for cleaning a floor surface (see, e.g., Patent Literature 1). The traveling section includes a pair of right and left wheels and two motors configured to drive each wheel in a forward rotation direction and a reverse rotation direction. The traveling section causes the vacuum body to travel in a front-back direction, and turns the vacuum body in an optional direction. The suction section includes a duct and an air blower communicating with the suction port, and a rotary brush provided at the suction port. The suction section is configured to suck, through the suction port, dust or the like. scraped off by the rotary brush.

Such a typical self-propelled vacuum is programmed to perform cleaning while self-propelling according to a preset traveling map. Moreover, in a case where a contact sensor has sensed contact with an obstacle such as a wall or furniture, the self-propelled vacuum returns to a route of the traveling map after having changed a traveling direction to avoid the obstacle.

### CITATION LIST

### Patent Literature

Patent Literature 1: JP-A-2016-135303

### SUMMARY

### Problems to be Solved by the Invention

However, in the typical self-propelled vacuum, contact with the obstacle is sensed by the contact sensor, and for this reason, the presence of the obstacle cannot be recognized until contact. Further, when the obstacle is avoided, avoidance operation is performed in a trial-and-error manner while contact with the obstacle is being repeatedly made, and for this reason, there is a problem that it takes time to cause the self-propelled vacuum to return to the route of the traveling map.

An object of the present invention is to provide a self-propelled vacuum configured so that obstacle avoidance operation can be efficiently performed and cleaning time can be shortened.

### Solutions to the Problems

The self-propelled vacuum of the present invention is a self-propelled vacuum for performing cleaning while traveling along a floor surface, the self-propelled vacuum including a vacuum body having a wheel for self-propelling, a traveling drive unit configured to drive the wheel, a peripheral sensing unit configured to sense the periphery of the vacuum body, an up-down drive unit configured to move the peripheral sensing unit up and down between a protrusion position above the vacuum body and a housing position in the vacuum body, a traveling control unit configured to control the traveling drive unit, and an up-down control unit configured to control the up-down drive unit. The up-down control unit drives the up-down drive unit to move the peripheral sensing unit up and down.

According to the present invention described above, the peripheral sensing unit at the protrusion position above the vacuum body senses therearound. Thus, an obstacle can be sensed across a broad area, and the traveling control unit can control the traveling drive unit according to the presence or absence and position of the obstacle to avoid the obstacle. Consequently, avoidance operation can be performed before contact with the obstacle, and an avoidance direction can be selected while the presence or absence of the obstacle in the avoidance direction is recognized. As a result, the avoidance operation can be efficiently performed, and cleaning time can be shortened.

Moreover, the up-down control unit drives the up-down drive unit to move the peripheral sensing unit up and down. Thus, a peripheral detection area can be changed, and the obstacle can be more efficiently detected. Further, the peripheral sensing unit is moved down so that cleaning can be performed without interference by the upwardly-protruding peripheral sensing unit and narrowing of a cleaning area.

In the present invention, in a case where the peripheral sensing unit has sensed an obstacle positioned above the vacuum body, the up-down control unit preferably moves the peripheral sensing unit down to a position at which the obstacle is avoided.

According to such a configuration, in a case where the obstacle positioned above the vacuum body is sensed and it is determined that the peripheral sensing unit is about to contact such an obstacle, the peripheral sensing unit can be moved down to avoid the obstacle, and the self-propelled vacuum can enter below the obstacle.

In the present invention, a sensing target portion is preferably provided in the vacuum body, and the peripheral sensing unit at the housing position preferably senses the sensing target portion to calibrate a measurement value of the peripheral sensing unit.

According to such a configuration, the peripheral sensing unit at the housing position senses the sensing target portion, and the measurement value of the peripheral sensing unit is calibrated based on such a result. Thus, the detection accuracy of the peripheral sensing unit can be favorably maintained.

In the present invention, the vacuum body is preferably provided with an opening which opens to a predetermined direction, and the peripheral sensing unit at the housing position preferably senses a predetermined direction of the vacuum body through the opening.

According to such a configuration, the peripheral sensing unit at the housing position performs sensing through the opening of the vacuum body. Thus, the obstacle in the predetermined direction can be sensed even when the peripheral sensing unit is housed in the vacuum body, and the avoidance operation can be performed.

In the present invention, the up-down control unit preferably transmits a message to a user by the up-down operation of moving the peripheral sensing unit up and down.

According to such a configuration, the message is transmitted to the user by the up-down operation of the peripheral sensing unit so that the state of the vacuum can be clearly transmitted and the peripheral sensing unit can be utilized as a user-friendly information transmission section (a user interface).

In the present invention, the self-propelled vacuum preferably further includes an external force sensing unit configured to sense external force acting on the peripheral sensing unit from the outside, and operation of the vacuum body is preferably switched based on sensing of the external force by the external force sensing unit.

According to such a configuration, the external force sensing unit senses the external force acting on the peripheral sensing unit, and based on such sensing, operation of the vacuum body is switched. Thus, the peripheral sensing unit can be utilized as a switch or an operation button.

In the present invention, the self-propelled vacuum preferably further includes an inclination drive unit configured to move the wheel up and down to change the inclination angle of the vacuum body with respect to the floor surface.

According to such a configuration, the inclination drive unit moves the wheel up and down to change the inclination angle of the vacuum body with respect to the floor surface so that the detection area of the peripheral sensing unit can be changed according to the inclination angle. For example, when the vacuum body is inclined such that the peripheral sensing unit faces downwardly to the front side, the obstacle near the floor surface on the front side is easily detectable. When the vacuum body is inclined such that the peripheral sensing unit faces upwardly to the front side, the obstacle positioned above is easily detectable, and the accuracy of detecting the obstacle can be improved.

### BRIEF DESCRIPTION OF THE DRAWINGS

FIG. 1 is a perspective view of a self-propelled vacuum according to a first embodiment of the present invention.

FIG. 2 is a sectional view of a state in which a peripheral sensing unit protrudes in the self-propelled vacuum.

FIG. 3 is a sectional view of a state in which the peripheral sensing unit is housed in the self-propelled vacuum.

FIG. 4 is a functional block diagram of an outline configuration of the self-propelled vacuum.

FIGS. 5(A) and 5(B) are perspective views of operation of the self-propelled vacuum.

FIG. 6 is a sectional view of operation in a state in which the peripheral sensing unit protrudes.

FIG. 7 is a sectional view of operation in a state in which the peripheral sensing unit is housed.

FIG. 8 is a sectional view of a self-propelled vacuum of a second embodiment of the present invention in a state in which a peripheral sensing unit protrudes.

FIG. 9 is a sectional view of a state in which the peripheral sensing unit is housed in the self-propelled vacuum.

FIG. 10 is a functional block diagram of an outline configuration of the self-propelled vacuum.

FIGS. 11(A) and 11(B) are perspective views of operation of the self-propelled vacuum.

FIG. 12 is a perspective view of another type of operation of the self-propelled vacuum.

FIGS. 13(A) and 13(B) are sectional views of other types of operation of the self-propelled vacuum.

### DESCRIPTION OF THE EMBODIMENTS

### First Embodiment

Hereinafter, a first embodiment of the present invention will be described with reference to FIGS. 1 to 7.

FIG. 1 is a perspective view of a self-propelled vacuum according to the first embodiment of the present invention.

As illustrated in FIG. 1, the self-propelled vacuum 1 is a cleaning robot configured to clean a floor surface F while traveling along the floor surface F, and includes a vacuum body 2 having wheels 111 for self-propelling and a sensor unit 3 having a laser range finder (LRF) 20 as a peripheral sensing unit configured to sense the periphery of the vacuum body 2.

The vacuum body 2 includes a body 10 having a cylindrical entire shape, a traveling drive unit 11 configured to drive the pair of wheels 111 for self-propelling, a control unit 12 configured to drivably control the traveling drive unit 11, a body operation unit 13 configured to operate the vacuum body 2, and a suction unit 14 provided at a lower surface of the body 10 to suck grit and dust on the floor surface F. The body 10 has a discoid upper surface 101 and a cylindrical side surface 102, and an inner bottom surface of the body 10 is provided with a not-shown chassis.

The sensor unit 3 includes a LRF 20, a tubular body 21 having a cylindrical entire shape and having an upper surface portion, an up-down drive unit 22 configured to move the tubular body 21 up and down relative to the vacuum body 2, a rotary drive unit 23 configured to rotate the LRF 20 inside the tubular body 21, and an upper sensor 24 configured to sense an obstacle positioned above the sensor unit 3. The LRF 20 is a laser distance meter configured to measure a distance by irradiation of laser light such as infrared laser, and calculates a distance to the obstacle from time until the irradiated laser light returns after having been reflected on the obstacle. At the tubular body 21, a window portion 211 allowing penetration of the laser light irradiated by the LRF 20 and the reflected light is provided continuously in a circumferential direction.

The body 10 is provided with a guide tube 103 opening at the upper surface 101 and configured to house the sensor unit 3, and an inner surface of the guide tube 103 is formed with guide grooves 104 for guiding the tubular body 21 up and down. Moreover, the side surface 102 of the body 10 is formed with an opening 105 allowing penetration of the laser light irradiated by the LRF 20 and the reflected light. The opening 105 is provided in a predetermined area along the circumferential direction of the side surface 102 on the front side of the vacuum body 2. Moreover, the opening 105 allows penetration of the laser light irradiated by the LRF 20 and the reflected light when the sensor unit 3 is housed in the vacuum body 2, and can sense the front side of the vacuum body 2 through the opening 105.

The traveling drive unit 11 includes the pair of right and left wheels 111 and a motor 112 configured to independently and rotatably drive the pair of wheels 111. Moreover, a safety wheel 113 is provided at a front portion of the body 10. The body operation unit 13 is provided with, e.g., a power ON/OFF button, a cleaning mode selection button, a stop button, and a charge button. A not-shown duct, a not-shown air blower, a not-shown dust collection chamber, and a not-shown exhaust port are connected to the suction unit 14, and collects sucked dust or the like. by a filter of the dust collection chamber and discharges sucked air through the exhaust port.

FIGS. 2 and 3 are sectional views of the electric vacuum, FIG. 2 illustrating a state in which the peripheral sensing unit protrudes and FIG. 3 being a sectional view of a state in which the peripheral sensing unit is housed.

As illustrated in FIGS. 2 and 3, the sensor unit 3 is movable up and down between a protrusion position (FIG. 2) protruding upward of the vacuum body 2 and a housing position (FIG. 3) housed in the guide tube 103 of the vacuum body 2. The protrusion position described herein means a height range from a lowermost protrusion position at which the LRF 20 slightly protrudes from the upper surface 101 of the vacuum body 2 to an uppermost protrusion position at which the sensor unit 3 is most moved upward from the guide tube 103.

A bottom portion of the tubular body 21 is provided with a support plate 212, and multiple protrusions 213 guided by the guide grooves 104 of the guide tube 103 are formed at the periphery of the support plate 212. Thus, the sensor unit 3 is supported by the guide tube 103 to freely move up and down along a vertical axis Z perpendicular to the upper surface 101 of the body 10 and not to rotate in a rotation direction R along a plane parallel to the upper surface 101 of the body 10.

The up-down drive unit 22 configured to move the sensor unit 3 up and down includes an up-down motor 221 fixed to the inside of the tubular body 21, multiple up-down gears 222 configured to decrease the number of rotations of an output shaft of the up-down motor 221, and a rack 223 fixed to the body 10 and engaging with a final gear of the up-down gears 222. The up-down drive unit 22 is configured to decelerate rotation of the up-down motor 221 by the up-down gears 222 to transmit such rotation to the rack 223, thereby moving the sensor unit 3 up and down along the rack 223.

The rotary drive unit 23 includes a rotary motor 231 fixed to the support plate 212 of the tubular body 21, a rotary gear 232 engaging with an output shaft of the rotary motor 231. and a rotary body 233 coupled to the rotary gear 232 to rotate about the vertical axis Z in the tubular body 21. The LRF 20 is fixed to the rotary body 233. The rotary drive unit 23 is configured to transmit rotation of the rotary motor 231 from the rotary gear 232 to the rotary body 233, thereby rotating the LRF 20 along the rotation direction R.

The upper sensor 24 is a distance sensor such as an ultrasonic sensor, and functions as an upper sensing section configured to upwardly irradiate an ultrasonic wave from an upper surface of the tubular body 21 to calculate the distance to the obstacle from time until the irradiated ultrasonic wave returns after having been reflected on the obstacle. For the upper sensor 24, ON/OFF of sensing is controlled by a command of the control unit 12. The upper sensor 24 is turned ON to sense the obstacle positioned above the sensor unit 3. Specifically, sensing is turned OFF in a case where the sensor unit 3 is at the uppermost protrusion position, and is turned ON in a case where the sensor unit 3 is moved down by a certain height from the uppermost protrusion position and a case where the sensor unit 3 is at the housing position.

FIG. 4 is a functional block diagram of an outline configuration of the self-propelled vacuum.

The control unit 12 of the vacuum body 2 includes a traveling control unit 121 configured to control the traveling drive unit 11, a suction control unit 122 configured to control the suction unit 14, a detection computing unit 123 configured to process detection signals from the LRF 20 and the upper sensor 24 to compute the distance to the peripheral obstacle, and a detection control unit 124 as an up-down control unit configured to drivably control the up-down drive unit 22 and the rotary drive unit 23.

FIGS. 5(A) and 5(B) are perspective views of operation of the self-propelled vacuum, FIG. 6 illustrates operation in a state in which the peripheral sensing unit protrudes, and FIG. 7 is a sectional view of operation in a state in which the peripheral sensing unit is housed.

Hereinafter, operation of the self-propelled vacuum 1 will be described with reference to FIGS. 5 to 7. When the self-propelled vacuum 1 is powered ON, the traveling control unit 121 of the control unit 12 drivably controls the traveling drive unit 11 according to a preset traveling program, thereby rotating the wheels 111 by the motor 112 to self-propel the vacuum body 2. In association with traveling of the vacuum body 2, the suction control unit 122 controls the suction unit 14 to start suction operation.

At the same time as the start of cleaning, the detection control unit 124 drives the up-down motor 221 of the up-down drive unit 22 to move the sensor unit 3 up to the protrusion position (the uppermost protrusion position), and drives the rotary motor 231 of the, rotary drive unit 23 to rotate the rotary body 233 and the LRF 20. Moreover, during traveling, the detection control unit 124 drives the up-down motor 221 of the up-down drive unit 22 to move the sensor unit 3 up and down within the range of the protrusion position, as necessary. As described above, the self-propelled vacuum 1 is self-propelled by the traveling drive unit 11 to clean the floor surface F by the suction unit 14 while detecting the presence or absence of the peripheral obstacle and the distance to the obstacle by the LRF 20 of the sensor unit 3 moved up to the protrusion position.

The detection computing unit 123 processes the detection signal transmitted from the LRF 20 to calculate the distance to the peripheral obstacle. The up-down motor 221 is a stepping motor of which rotation angle is controlled by the detection control unit 124, and the detection computing unit 123 calculates the height position of the sensor unit 3 from the rotation angle of the up-down motor 221. The rotary motor 231 is a stepping motor of which rotation angle is controlled by the detection control unit 124, and the detection computing unit 123 calculates the rotation positions of the rotary body 233 and the LRF 20 from the rotation angle of the rotary motor 231.

As illustrated in FIG. 6, in a case where the sensor unit 3 is at the protrusion position, the rotary drive unit 23 rotates the rotary body 233 approximately 360° about the vertical axis Z by the rotary motor 231, and detects the obstacle across the substantially entire circumference of the vacuum body 2 by the LRF 20. That is, the detection computing unit 123 executes computation based on the height position and rotation position of the LRF 20 and the distance to the obstacle, thereby three-dimensionally recognizing the position of the obstacle at the periphery of the vacuum body 2.

Specifically, as illustrated in FIG. 5(A), in a case where an obstacle S such as a sofa or a table has been detected on the front side in a traveling direction, the detection control unit 124 drives the up-down motor 221 of the up-down drive unit 22 to move the sensor unit 3 down. In a case where there is a clearance between a bottom surface Si of the detected obstacle S and the floor surface F, the obstacle S is no longer detected as the sensor unit 3 moves down, and the detection computing unit 123 can recognize the height of the bottom surface S1 of the obstacle S. Thus, the detection computing unit 123 determines whether or not traveling in the clearance between the bottom surface S1 of the obstacle S and the floor surface F is allowed.

The detection computing unit 123 determines, based on the height of the clearance, whether traveling is allowed in a state in which the sensor unit 3 is at the protrusion position, traveling is allowed after the sensor unit 3 has been moved down to the housing position, or traveling is not allowed even after the sensor unit 3 has been moved down to the housing position. In a case where it is determined that traveling is not allowed, the self-propelled vacuum 1 gives up on entering below the obstacle S, and moves to the nearest traveling route according to the traveling program to continue cleaning In a case where it is determined that traveling is allowed in a state in which the sensor unit 3 is at the protrusion position, the self-propelled vacuum 1 enters below the obstacle S to continue cleaning as illustrated in FIG. 5(B).

When the sensor unit 3 is moved down such that the self-propelled vacuum 1 enters below the obstacle S as described above, the control unit 12 activates the upper sensor 24 to start sensing, and the detection computing unit 123 processes the detection signal transmitted from the upper sensor 24 to calculate a distance to the bottom surface Si of the obstacle S. When the self-propelled vacuum 1 moves out of the clearance between the bottom surface Si of the obstacle S and the floor surface F and the upper sensor 24 no longer senses the bottom surface S1, the detection control unit 124 drives the up-down motor 221 of the up-down drive unit 22 to move the sensor unit 3 up to the protrusion position, and the control unit 12 stops the upper sensor 24 and continues cleaning.

On the other hand, in a case where traveling is allowed after the sensor unit 3 has been moved down to the housing position, the detection control unit 124 moves the sensor unit 3 down to the housing position. In a case where the sensor unit 3 is at the housing position, the LRF 20 can sense, as illustrated in FIG. 7, a predetermined area on the front side of the vacuum body 2 through the opening 105 of the body 10. For example, the width dimension of the opening 105 is set such that the sensing area of the LRF 20 is approximately 90°. Moreover, the rotary drive unit 23 rotates the rotary body 233 by a range of approximately 90° on the front side by the rotary motor 231, thereby detecting the obstacle on the front side of the vacuum body 2 by the LRF 20.

After the sensor unit 3 has been moved down to the housing position, in a case where the front side of the vacuum body 2 is sensed by the LRF 20 and no obstacle on the front side is detected, the traveling control unit 121 drives the traveling drive unit 11 in a forward movement direction, and the self-propelled vacuum 1 enters the clearance between the bottom surface SI of the obstacle S and the floor surface F to continue cleaning. When the self-propelled vacuum 1 enters the clearance, the control unit 12 activates the upper sensor 24 to sense the bottom surface S1 of the obstacle S. Thereafter, when the upper sensor 24 no longer senses the bottom surface S1, the detection control unit 124 drives the up-down motor 221 of the up-down drive unit 22 to move the sensor unit 3 up to the protrusion position.

In a case where the obstacle is detected on the front side of the vacuum body 2 after the self-propelled vacuum 1 has entered the clearance between the bottom surface S1 of the obstacle S and the floor surface F in a state in which the sensor unit 3 is at the housing position, the traveling control unit 121 drives the traveling drive unit 11 to turn or backwardly move the self-propelled vacuum 1, and causes the self-propelled vacuum 1 to return to the traveling route according to the traveling program after having avoided the obstacle. When the self-propelled vacuum 1 returns to the traveling route and the upper sensor 24 confirms that no obstacle is present above, the detection control unit 124 drives the up-down motor 221 of the up-down drive unit 22 to move the sensor unit 3 up to the protrusion position, and resumes cleaning according to the traveling program.

When the predetermined traveling program ends as described above, the traveling control unit 121 stops the traveling drive unit 11, and the suction control unit 122 stops operation of the suction unit 14. Further, the detection control unit 124 drives the up-down motor 221 of the up-down drive unit 22 to move the sensor unit 3 down to the housing position, and stops the rotary motor 231 of the rotary drive unit 23. The control unit 12 brings the self-propelled vacuum 1 into a standby state.

In the standby state of the self-propelled vacuum 1, the control unit 12 performs calibration regarding the detected distance, height position, and rotation position of the LRF 20. As illustrated in FIG. 7, a slit 106 is formed at part of the guide tube 103 of the vacuum body 2, and a wall portion 107 as a sensing target portion is provided corresponding to the slit 106 in the body 10. The wall portion 107 is provided apart from the LRF 20 by a known distance L, and is configured to reflect the laser light irradiated from the LRF 20 through the slit 106. Thus, the LRF 20 detects the distance based on the reflected light from the wall portion 107, and the detection computing unit 123 calculates a difference between such a detected distance and the known distance L. In a case where there is a deviation in the detected distance, the detection computing unit 123 outputs, in subsequent detection, the detected distance after such a deviation amount has been corrected.

Patterns for changing the intensity of the reflected light in the vertical direction (a direction along the vertical axis Z) and the horizontal direction (a direction along the rotation direction R) are provided at a surface of the wall portion 107. These patterns are absolute patterns for detecting an absolute position in each of the vertical direction and the horizontal direction. The LRF 20 receives the reflected light provided from each pattern, and the detection computing unit 123 calculates the absolute position of the LRF 20 in the vertical direction and the horizontal direction. Thus, in a case where there is a deviation among the calculated absolute position of the LRF 20, the height position by the up-down motor 221 of the up-down drive unit 22, and the rotation position by the rotary motor 231 of the rotary drive unit 23, the detection computing unit 123 outputs, in subsequent detection, the height position and the rotation position for which such a deviation amount has been corrected.

According to the present embodiment described above, the following features/advantageous effects can be provided.

(1) The LRF 20 at the protrusion position above the upper surface 101 of the vacuum body 2 senses therearound. Thus, the obstacle can be sensed within a broad area, and according to the presence or absence and position of the obstacle, the traveling control unit 121 can control the traveling drive unit 11 to avoid the obstacle. Thus, avoidance operation can be performed before contact with the obstacle, and an avoidance direction can be selected while the presence or absence of the obstacle in the avoidance direction is recognized. Thus, the avoidance operation can be efficiently performed, and cleaning time can be shortened.

(2) The detection control unit 123 drives the up-down drive unit 22 to move the LRF 20 up and down so that a peripheral detection area can be changed and the obstacle can be more efficiently detected. Moreover, after the LRF 20 has been moved down to the housing position, cleaning can be performed without interference by the upwardly-protruding sensor unit 3 and narrowing of a cleaning area.

(3) In a case where the obstacle positioned above the vacuum body 2 is sensed and it is determined that the sensor unit 3 is about to contact such an obstacle, the sensor unit 3 can be moved down to avoid the obstacle, and the self-propelled vacuum 1 can enter below the obstacle.

(4) The LRF 20 at the housing position senses the wall portion 107, and the detected distance of the LRF 20 is calibrated based on such a result. Thus, the detection accuracy of the LRF 20 can be favorably maintained. Further, the absolute position of the LRF 20 in the vertical direction and the horizontal direction is calculated based on the reflected light from the wall portion 107, and based on such a result, the height position and rotation position of the LRF 20 are calibrated. Thus, the accuracy of detecting the obstacle by the LRF 20 can be improved.

(5) The LRF 20 at the housing position senses the predetermined region on the front side through the opening 105 of the vacuum body 2. Thus, the obstacle on the front side can be sensed even when the LRF 20 is housed in the vacuum body 2, and cleaning can be performed while the avoidance operation is being performed.

(6) The upper sensor 24 senses the obstacle positioned above the sensor unit 3. Thus, when the sensor unit 3 is moved up after the sensor unit 3 has been moved down to avoid the obstacle, the sensor unit 3 can be moved up to the uppermost protrusion position without collision with the obstacle, and cleaning can be performed while the obstacle is being sensed across a broad area.

### Second Embodiment

FIGS. 8 and 9 are sectional views of a self-propelled vacuum according to a second embodiment of the present invention, FIG. 8 illustrating a state in which a peripheral sensing unit protrudes and FIG. 9 being a sectional view of a state in which the peripheral sensing unit is housed. FIG. 10 is a functional block diagram of an outline configuration of the self-propelled vacuum.

The self-propelled vacuum 1 of the present embodiment is different from that of the first embodiment in configurations of an up-down drive unit 22 configured to move a sensor unit 3 up and down and a rotary drive unit 23 configured to rotate a LRF 20. Moreover, the self-propelled vacuum 1 of the present embodiment is different from that of the first embodiment in that the self-propelled vacuum 1 includes an inclination drive unit 15 at a vacuum body 2, includes an external force sensing unit 25 at the sensor unit 3, and includes a power control unit 125 and an inclination control unit 126 at a control unit 12.

As illustrated in FIGS. 8 to 10, the vacuum body 2 is provided with the inclination drive unit 15 configured to move wheels 111 up and down to change the inclination angle of the vacuum body 2 with respect to a floor surface F. The inclination drive unit 15 includes an arm 151 of which one end side is rotatably supported by the vacuum body 2 and of which other end side is coupled to a motor 112 of a traveling drive unit 11, and an actuator 152 configured to drive the arm 151 in an up-down direction. The inclination control unit 126 drive the actuator 152 to extend or contract the actuator 152, thereby moving the wheels 111 up and down through the arm 151 to change the inclination angle of the vacuum body 2.

The up-down drive unit 22 includes a direct-acting motor 224 fixed to a bottom portion of the vacuum body 2, and a flange 226 fixed to an upper end portion of an output shaft 225 of the direct-acting motor 224. A support plate 212 of a tubular body 21 is rotatably mounted on the upper side of the flange 226. The up-down drive unit 22 is configured to extend or contract the direct-acting motor 224 to move the sensor unit 3 up and down. Moreover, the direct-acting motor 224 is provided with the external force sensing unit 25 configured to sense external force acting on the sensor unit 3 from the outside. When the external force of pressing down the sensor unit 3 from above acts on the direct-acting motor 224 through the output shaft 225, the external force sensing unit 25 senses such external force to transmit a sensing signal to the control unit 12.

The rotary drive unit 23 includes a rotary motor 234 fixed to the support plate 212 of the tubular body 21, and an output shaft of the rotary motor 234 is coupled to the flange 226. Moreover, in the present embodiment, the LRF 20 is fixed to the tubular body 21 and the support plate 212 of the sensor unit 3. The rotary drive unit 23 rotates the rotary motor 234 to rotate the support plate 212, the tubular body 21, and the LRF 20 relative to the flange 226. Multiple iron balls 214 are rotatably provided at a lower outer peripheral surface of the tubular body 21, and function as ball bearings configured to roll along an inner surface of a guide tube 103 when the tubular body 21 moves up and down and rotates in the guide tube 103 of a body 10 to smoothly guide the sensor unit 3 relative to the guide tube 103.

FIG. 11 is a perspective view of operation of the self-propelled vacuum of the present embodiment.

In the self-propelled vacuum 1 of the present embodiment, the sensor unit 3 also functions as a power button of the self-propelled vacuum 1. Specifically as illustrated in FIG. 11(A), in a case where the self-propelled vacuum 1 is in a standby state and the sensor unit 3 is at a housing position, when a user presses down the sensor unit 3, such pressing force is sensed by the external force sensing unit 25. When the control unit 12 receives a sensing signal from the external force sensing unit 25, the power control unit 125 powers ON the self-propelled vacuum 1 to activate the self-propelled vacuum 1. On the other hand, in a case where the sensor unit 3 is at a protrusion position during operation of the self-propelled vacuum 1, when the user presses down the sensor unit 3, such pressing force is sensed by the external force sensing unit 25, and the power control unit 125 powers OFF the self-propelled vacuum 1 to bring the self-propelled vacuum 1 into the standby state.

As in the upper sensor 24 of the first embodiment, the external force sensing unit 25 also functions as an upper sensing section configured to sense an obstacle positioned above the sensor unit 3. That is, as illustrated in FIG. 5 of the first embodiment, when the self-propelled vacuum 1 enters a clearance between a bottom surface S1 of an obstacle S and the floor surface F to perform cleaning, a detection control unit 123 drives the up-down drive unit 22 to move the sensor unit 3 up at proper timing. When the sensor unit 3 contacts the bottom surface S1 of the obstacle S, external force acting from the bottom surface Si is sensed by the external force sensing unit 25, and therefore, it is recognized that the obstacle S is present above. The detection control unit 123 moves the sensor unit 3 down. On the other hand, in a case where the sensor unit 3 is moved up and does not contact the obstacle S, the detection control unit 123 moves the sensor unit 3 up to an uppermost protrusion position.

FIG. 12 is a perspective view of another type of operation of the self-propelled vacuum of the present embodiment.

In the self-propelled vacuum 1 of the present embodiment, the sensor unit 3 also functions as a transmission section configured to transmit a message to the user by up-down operation of the sensor unit 3. Specifically, as illustrated in FIG. 12, in a case where the sensor unit 3 is at the protrusion position, the detection control unit 123 drives the up-down drive unit 22 to move the sensor unit 3 up and down, or the detection control unit 123 drives the rotary drive unit 23 to rotate the sensor unit 3 or to rotate the sensor unit 3 while moving the sensor unit 3 up and down. In this manner, e.g., the state of the self-propelled vacuum 1 is transmitted to the user.

The state of the self-propelled vacuum 1 as described herein includes, for example, various types of information such as a state in which a battery charge has decreased, a state in which dust collected to a dust collection chamber has reached a predetermined capacity, a state in which the timing of replacing a filter of the dust collection chamber has come, a state in which cleaning according to a traveling program has completed, and a state in which cleaning according to the traveling program cannot be performed due to the obstacle. Moreover, feeling expression of the self-propelled vacuum 1 as a cleaning robot, such as delight, anger, sorrow, and pleasure, may be transmitted to the user by operation of the sensor unit 3. Multiple states can be expressed as such up-down operation of the sensor unit 3 by a combination of the number of times of up-down movement, an up-down speed, the number of rounds of rotation, and a rotation speed.

FIG. 13 is a sectional view of still another type of operation of the self-propelled vacuum of the present embodiment.

As illustrated in FIG. 13(A), the inclination drive unit 15 extends the actuator 152 to move the wheels 111 down through the arm 151, thereby moving a back portion of the vacuum body 2 up to incline the self-propelled vacuum 1 downwardly to the front side. As described above, the entirety of the self-propelled vacuum 1 is at the angle of downward inclination to the front side. Thus, the sensing area of the LRF 20 is on a near side (a side closer to the self-propelled vacuum 1) of the floor surface F toward the front side, and is on an upper far side toward the back side.

As illustrated in FIG. 13(B), the inclination drive unit 15 contracts the actuator 152 to move the wheels 111 up through the arm 151, thereby moving the back portion of the vacuum body 2 down to incline the self-propelled vacuum 1 upwardly to the front side. As described above, the entirety of the self-propelled vacuum 1 is at the angle of upward inclination to the front side. Thus, the sensing area of the LRF 20 is on the far side of the floor surface F toward the front side, and is on the near side toward the back side.

As described above, in the present embodiment, the inclination angle of the entirety of the self-propelled vacuum 1 is changed so that the sensing area of the LRF 20 can be changed. Thus, as in the first embodiment, the LRF 20 senses, in addition to up-down movement of the sensor unit 3, therearound during rotation in a state in which the inclination angle of the entirety of the self-propelled vacuum 1 has been changed during cleaning according to the traveling program. In this manner, the area of sensing of the peripheral obstacle can be expanded three-dimensionally

According to the present embodiment described above, the following features/advantageous effects can be provided in addition to the above-described advantageous effects (1) to (5).

(7) The external force sensing unit 25 senses the external force acting on the sensor unit 3 so that the sensor unit 3 can function as the power button of the self-propelled vacuum 1 and can also function as the upper sensing section configured to sense the obstacle positioned above.

(8) The message is transmitted to the user by the up-down operation and rotation operation of the sensor unit 3 so that the state of the self-propelled vacuum 1 can be clearly transmitted and the sensor unit 3 can be utilized as a user-friendly information transmission section (a user interface).

(9) The inclination angle of the entirety of the self-propelled vacuum 1 is changed by the inclination drive unit 15 so that the sensing area of the LRF 20 can be three-dimensionally expanded and the accuracy of detecting the peripheral obstacle can be improved.

### Variations of Embodiments

Note that the present invention is not limited to the above-described embodiments, and variations, modifications and the like within a scope in which an object of the present invention can be achieved are included in the present invention.

For example, in the above-described embodiments, the LRF 20 is used as the peripheral sensing unit, and the peripheral sensing unit is not limited to the laser range finder (LRF) 20. An optional sensing section can be utilized. For example, the sensing section may be an ultrasonic sensor, an optical sensor, or an electromagnetic sensor, or may be an image capturing section such as a CCD camera. In the case of using the image capturing section, it may be configured such that, e.g., an image processing section is provided at the control unit to sense the peripheral obstacle by image analysis.

In the above-described first embodiment, the LRF 20 is driven and rotated by the rotary drive unit 23 in the sensor unit 3. In the above-described second embodiment, the LRF 20 is, together with the sensor unit 3, rotated by the rotary drive unit 23. However, the peripheral sensing unit is not limited to one to be rotated. That is, the peripheral sensing unit may include multiple sensors configured to sense different directions. With this configuration, the rotary drive unit can be omitted. Moreover, in the above-described embodiments, the opening 105 of the vacuum body 2 is provided on the front side, but may be provided at an optional position of the vacuum body.

Moreover, in the above-described first embodiment, the up-down drive unit 22 includes the up-down motor 221, the up-down gears 222, and the rack 223. In the above-described second embodiment, the up-down drive unit 22 includes the direct-acting motor 224. However, the configuration of the up-down drive unit is not limited to those of the above-described embodiments, and various drive mechanisms can be utilized. Further, the rotary drive unit configured to rotate the peripheral sensing unit and the inclination drive unit configured to move the wheels up and down are not limited to those of the configurations of the above-described embodiments, and various drive mechanisms can be utilized.

In the above-described first embodiment, the upper sensor 24 senses the obstacle positioned above the sensor unit 3. in the above-described second embodiment, the external force sensing unit 25 senses the obstacle positioned above. However, such an upper sensing section is not necessarily provided, and can be omitted. In a case where the upper sensing section is omitted, the obstacle positioned above may be sensed using the peripheral sensing unit, or the peripheral sensing unit may be moved up and down without sensing the obstacle positioned above.

In the above-described second embodiment, the external force sensing unit 25 senses the user's operation of pressing down the sensor unit 3 such that the sensor unit 3 functions as the power button of the self-propelled vacuum 1. However, the operation of pressing down the sensor unit 3 is not limited to ON/OFF of the power. Such operation may be utilized for pause/resumption of the self-propelled vacuum 1, or may be utilized for switching a cleaning mode. The sensor unit 3 can function as an operation unit configured to execute optional operation.

### INDUSTRIAL APPLICABILITY

As described above, the present invention can be suitably utilized for a self-propelled vacuum configured so that obstacle avoidance operation can be efficiently performed and cleaning time can be shortened.

### LIST OF REFERENCE NUMERALS

1 self-propelled vacuum

2 vacuum body

3 sensor unit

10 body

11 traveling drive unit

12 control unit

15 inclination drive unit

20 LRF (peripheral sensing unit)

22 up-down drive unit

23 rotary drive unit

25 external force sensing unit

105 opening

107 wall portion (detection target portion)

111 wheel

121 traveling control unit

124 detection control unit (up-down control unit)

F floor surface

What is claimed is:

1. A self-propelled vacuum for performing cleaning while traveling along a floor surface, comprising:
a vacuum body having a wheel for self-propelling;
a traveling drive unit configured to drive the wheel;
a peripheral sensing unit configured to sense a periphery of the vacuum body;
an up-down drive unit configured to move the peripheral sensing unit up and down between a protrusion position above the vacuum body and a housing position in the vacuum body;
a traveling control unit configured to control the traveling drive unit; and
an up-down control unit configured to control the up-down drive unit,
wherein the up-down control unit drives the up-down drive unit to move the peripheral sensing unit up and down.

2. The self-propelled vacuum according to claim 1, wherein
in a case where the peripheral sensing unit has sensed an obstacle positioned above the vacuum body, the up-down control unit moves the peripheral sensing unit down to a position at which the obstacle is avoided.

3. The self-propelled vacuum according to claim 1, wherein
a sensing target portion is provided in the vacuum body, and
the peripheral sensing unit at the housing position senses the sensing target portion to calibrate a measurement value of the peripheral sensing unit.

4. The self-propelled vacuum according to claim 1, wherein
the vacuum body is provided with an opening which opens to a predetermined direction, and
the peripheral sensing unit at the housing position senses a predetermined direction of the vacuum body through the opening.

5. The self-propelled vacuum according to claim 1, wherein
the up-down control unit transmits a message to a user by an up-down operation of moving the peripheral sensing unit up and down.

6. The self-propelled vacuum according to claim 1, further comprising:
an external force sensing unit configured to sense external force acting on the peripheral sensing unit from an outside,
wherein operation of the vacuum body is switched based on sensing of the external force by the external force sensing unit.

7. The self-propelled vacuum according to claim 1, further comprising:
an inclination drive unit configured to move the wheel up and down to change an inclination angle of the vacuum body with respect to the floor surface.
